(19) United States
(12) Patent Application Publication
(10) Pub. No.: US 2014/0204368 A1
(43) Pub. Date: Jul. 24, 2014

(54) Fibre Optic Distributed Sensor

(71) Applicants: Andrew Lewis, Portishead (GB); Stuart Russell, Portishead (GB)

(72) Inventors: Andrew Lewis, Portishead (GB); Stuart Russell, Portishead (GB)

(73) Assignee: OPTASENSE HOLDINGS LIMITED, Farnborough, Hampshire (GB)

(21) Appl. No.: 14/237,723

(22) PCT Filed: Aug. 24, 2012
(86) PCT No.: PCT/GB2012/052095

§ 371 Date: Feb. 7, 2014

(30) Foreign Application Priority Data
Aug. 25, 2011 (GB) 1114717.0

(51) Int. Cl. G01M 11/00

(52) U.S. Cl. CPC G01M 11/30
USPC 356/73.1

(57) ABSTRACT

There is provided a distributed sensor, comprising a length of optic fibre; an interrogator unit having a detector arranged to detect light from the optic fibre, wherein the interrogator is arranged to provide distributed sensing on the optic fibre and wherein an optical path is defined between the optic fibre and the interrogator detector; a sampler coupled to the optic fibre and arranged to obtain a sample of light from the optical path of the optic fibre; a threshold detector arranged to detect the intensity of the sampled light and determine whether the intensity of the sampled light is above a threshold value; and an optical attenuator provided in the optical path and arranged to attenuate light propagating along the optical path when the intensity of the sampled light is above the threshold value. By attenuating light in the optical path if it is above a threshold value, the sensitive detector in the interrogator unit can be protected.

The present invention relates to a fibre optic distributed sensor apparatus and a method of fibre optic distributed sensing, in particular, it relates to a fibre optic distributed sensor apparatus that prevents saturation and damage of the sensor.

Fibre optic distributed sensors are known and generally comprise a length of optic fibre and an interrogator unit arranged to transmit interrogating electromagnetic radiation into the optic fibre and detect backscattered radiation from within said optic fibre in order perform distributed sensing. The optic fibre distributed sensor may use the principles of Rayleigh scattering, Raman scattering and/or Brillouin scattering to detect changes in the characteristics of the optic fibre hence of the surrounding environment.

The backscattered radiation is usually of a very low intensity, and it is therefore necessary that a high sensitivity detector is provided in the interrogator unit in order to detect the back scattered signals.

It is desirable to provide an improved fibre optic distributed sensor apparatus.

According to an aspect of the present invention, there is provided an apparatus for distributed fibre optic sensing, comprising: an interrogator unit configured, in use, to interrogate an optic fibre with interrogating radiation and detect radiation backscattered from said optic fibre, the interrogator unit comprising: a first detector configured to receive radiation from said optic fibre; an intensity detector configured to determine an intensity level of the radiation received from the optic fibre; and an optical attenuator configured to attenuate radiation passing from the optic fibre to the first detector in response to the intensity detector.

The distributed sensor of the present invention ensures that, by detecting the intensity of the signal received from the optic fibre, if a signal is present with an intensity that is at a level that could damage or impair the sensor apparatus, this signal can be attenuated such that the saturation of and/or damage to the detector and the interrogator can be prevented.

The intensity detector may comprise a second detector configured to determine an intensity level of the radiation received from the optic fibre.

The intensity detector may comprise an optical coupler configured to couple a portion of the radiation passing from the optical fibre to the first detector for detection by the second detector. The optical coupler may be a tap coupler. The tap coupler may be configured to tap a small proportion of the light from the optic fibre for intensity detection. In other words the optical coupler is arranged so that the second detector samples a small proportion of the backscattered radiation. The optical coupler may tap only a small proportion of the backscattered radiation so as to minimise the impact on the signal strength of the light incident at the first detector. The tap coupler may tap 25% or less of the light from the optic fibre, i.e. the intensity of the radiation coupled for the second detector may be at most 25% of the intensity of the light received at the coupler from the optic fibre . Preferably, the tap coupler may tap 10% or less of the light from the optic fibre.

The apparatus may further comprise a gain element configured to apply a gain to the portion of the radiation coupled for detection by the second detector. The gain element may be an amplifier configured to amplify the coupled portion of the radiation. As the light sampled for intensity detection is a small proportion of the light in the optic fibre, it may be amplified such that a signal of larger intensity can be used by the intensity detector.

The intensity detector may comprise a threshold detector configured to determine if the intensity level of the radiation received from the optic fibre is above a threshold level.

The threshold value may be a predetermined threshold value.

The threshold value may be a variable threshold value, wherein the threshold value is set in accordance with the gain of the gain element.

The optical attenuator may be configured to selectively, e.g. when activated, apply attenuation at a fixed level to the radiation passing from the optic fibre to the first detector. The optic attenuator may be an optical switch that is configured to be closed, i.e. to substantially block or attenuate light, when the intensity of the sampled light is above the threshold value. In other words, if the intensity of the sampled light indicates that the light in the optic fibre is above a threshold and may damage the detector and the associated electronics in the interrogator unit, the switch is closed and the light in the optic fibre is prevented from being incident on the interrogator detector. If however the intensity of the sampled light indicates that the intensity of the backscattered radiation is below the threshold then the attenuator may apply no attenuation to the light passing from the optic fibre to the first detector. For the avoidance of doubt therefore in some embodiments the attenuator may be arranged such that substantially no attenuation is applied if the backscatter radiation is below a certain threshold.

The distributed sensor may further comprise a switch controller configured to control the optical switch based on the output of the threshold detector.

The optical attenuator may be configured to apply a variable attenuation to the radiation passing from the optic fibre to the first detector. The distributed sensor may further comprise an attenuation controller arranged to vary the level of attenuation in dependence on the intensity level of the radiation received from the optic fibre.

The distributed sensor may further comprise a delay in the optical path between the optic fibre and the first detector or between the tap point of the optical coupler and the attenuator. The delay may be an optical delay coil.

The delay in the optical path compensates for the delay in the electronics processing of the detected tap signal and operating the optical switch. This delay may typically be of the order of a few hundred of nanoseconds. The optical signal in the optical path is therefore delayed to ensure that the optical signal does not arrive at the detector before any necessary attenuation can be applied.

The intensity detector may be configured to continuously determine the intensity of the radiation received from the optic fibre. By continuously determining the intensity of the radiation received from the optic fibre the optical path, continuous monitoring for large signals in the optic fibre can be provided.

The interrogator may further comprise a light source for transmitting light into the optic fibre. The interrogator detector may be arranged to detect backscattered light. The distributed sensor may be a distributed acoustic sensor.

According to another aspect of the present invention, there is provided a method of fibre optic distributed sensing, comprising: interrogating an optic fibre with interrogating radiation; determining an intensity level of backscattered radiation received from the optic fibre; and attenuating the radiation received from the optic fibre in response to the determined intensity level.

The invention may comprise any combination of the features and/or limitations referred to herein, except combinations of such features as are mutually exclusive.

Embodiments of the present invention will now be described, by way of example, with reference to the accompanying drawings, in which:

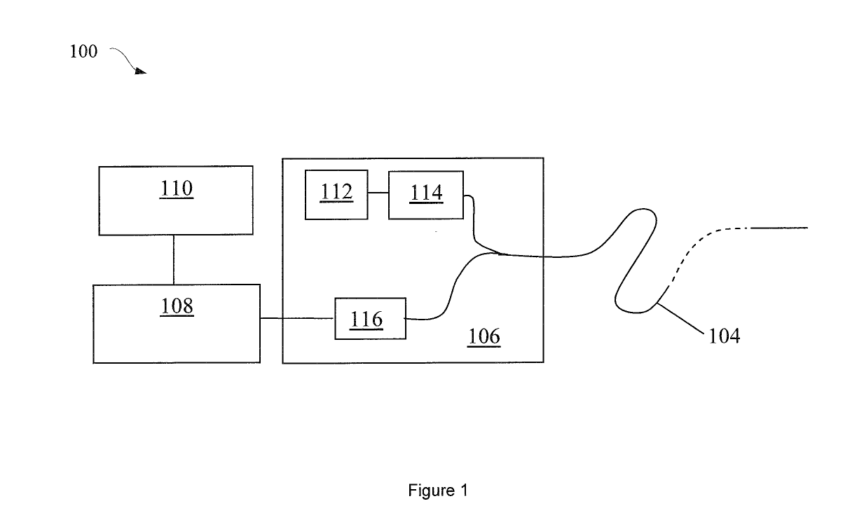

FIG. 1 schematically shows a known distributed sensor;

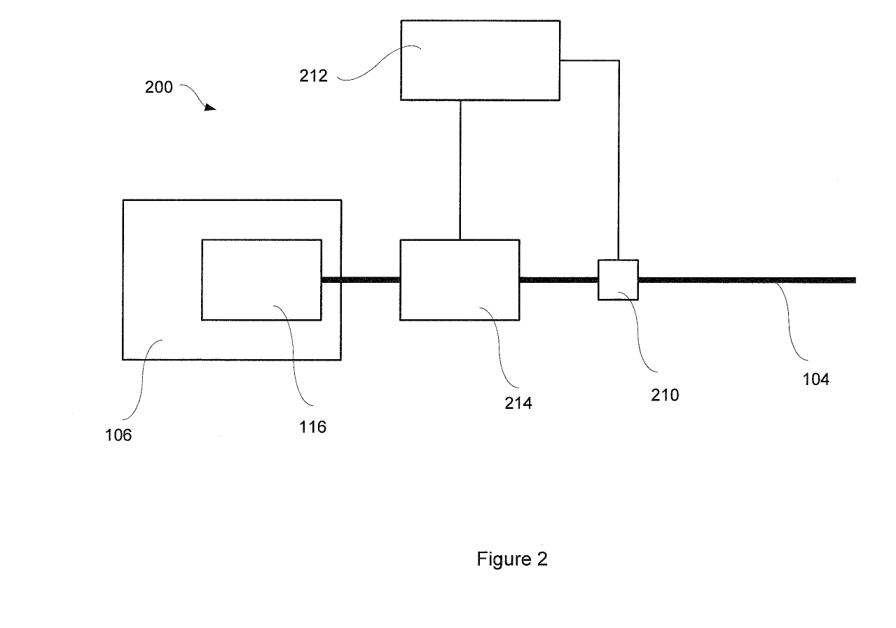

FIG. 2 schematically shows a distributed sensor according to an embodiment of the present invention; and

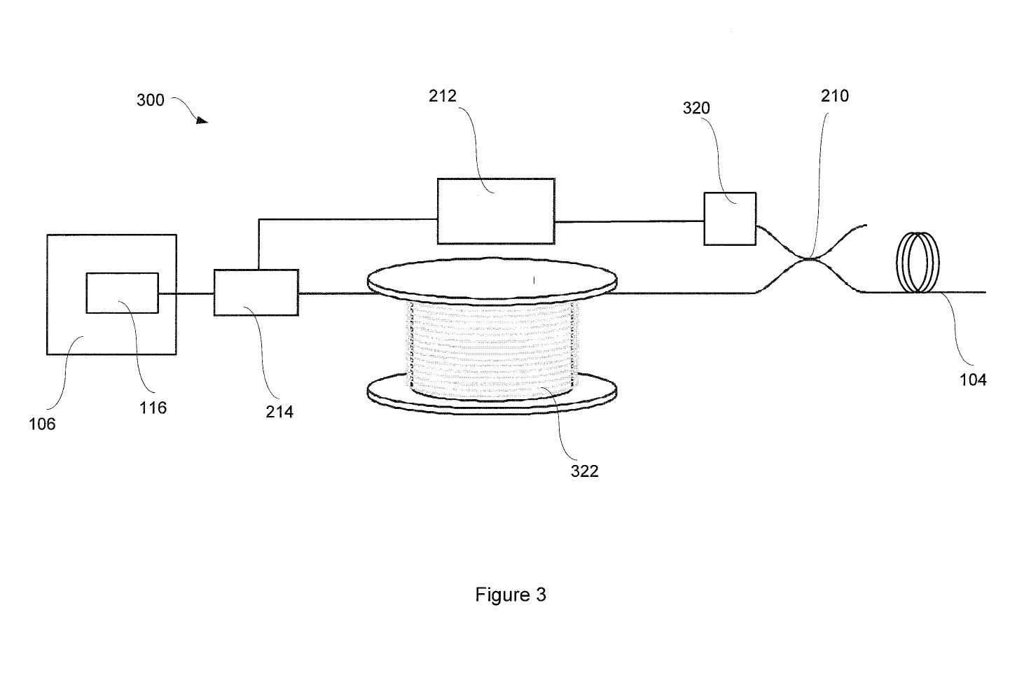

FIG. 3 shows a distributed sensor according to another embodiment of the present invention.

FIG. 1 shows a schematic of a distributed fibre optic sensing arrangement 100. The fibre optic distributed sensor of FIG. 1 will be described in relation to a distributed sensor that is arranged to detect Rayleigh backscattered light. However, it will be appreciated that the distributed sensor of FIG. 2 may be a distributed sensor that additionally or alternatively uses the principles of Raman scattering and/or Brillouin scattering.

A length of sensing fibre 104 is removably connected at one end to an interrogator 106. The output from interrogator 106 is passed to a signal processor 108, which may be co-located with the interrogator or may be remote therefrom, and optionally a user interface/graphical display 110, which in practice may be realised by an appropriately specified PC. The user interface may be co-located with the signal processor or may be remote therefrom.

The sensing fibre 104 can be many kilometres in length and may, for example, be up to 40 km long. The sensing fibre may be a standard, unmodified single mode optic fibre such as is routinely used in telecommunications applications.

In operation the interrogator 106 launches interrogating electromagnetic radiation, which may for example comprise a series of optical pulses having a selected frequency pattern, into the sensing fibre. Note that as used herein the term “optical” is not restricted to the visible spectrum and optical radiation includes infrared radiation and ultraviolet radiation. The phenomenon of Rayleigh backscattering results in some fraction of the light input into the fibre being reflected back to the interrogator, where it is detected to provide an output signal which is representative of acoustic disturbances in the vicinity of the fibre. The interrogator may therefore comprise at least one laser 112 and at least one optical modulator 114 for producing a plurality of optical pulse separated by a known optical frequency difference. The interrogator also comprises at least one photodetector 116 arranged to detect radiation which is Rayleigh backscattered from the intrinsic scattering sites within the fibre 104.

The photodetector 116 is used to detect small backscattered signals that may have travelled many kilometres and may have faded due to inherent losses in the fibre. It is therefore necessary for the detector 116 to have a very high sensitivity such that the backscattered signals can be detected. The photodetector may be a high sensitivity charge-coupled device (CCD).

The signal from the photodetector 116 is processed by signal processor 108. The signal processor demodulates the returned signal, for example based on the frequency difference between the optical pulses. The phase of the backscattered light from various sections of the optical fibre can therefore be monitored. Any changes in the effective path length from a given section of fibre, such as would be due to incident pressure waves causing strain on the fibre, can therefore be detected.

The distributed sensing system of FIG. 1 is often used with pre-installed optical fibres. In application such as sensing in well bores, telecommunication fibres that are installed during the well production installation process and upon completion of the well, may be used. However, these pre-installed fibres are generally inaccessible after completion of the well and before any distributed sensing is performed on the fibre, it is unknown what the condition of the pre-installed fibre is.

In the application of perimeter, border or pipeline monitoring, an optic fibre may be buried along the path to be monitored. As the optic fibre is buried, it is generally inaccessible and therefore, before any distributed sensing is performed on the buried fibre, again the condition of the pre-installed fibre is unknown. For example, there is a possibility that the optic fibre may have been severed during earth excavation, but this may not be known until an interrogator pulse is introduced into the fibre.

Pre-installed optic fibres may have poorly spliced interconnectors whereby an abnormally large amount of incident light is backscattered along the fibre from the poorly spliced interconnect. Also, two or more optic fibres may be connected together with dirty connectors, which may also cause an abnormally large amount of backscattered light. Further, the pre-installed optic fibre may be broken, which may again cause an abnormally large amount of reflected light.

In addition, in some situations, a Fabry-Perot interferometer may be installed at the end of a pre-installed optic fibre, which would again lead to a large amount of the incident light being reflected back down the optic fibre.

In all of the situations described above, upon sending an interrogating signal down the optic fibre, an unexpected signal of large intensity may be reflected back down the optic fibre towards the interrogator unit 106. As described above, the photodetector 116 is a high sensitivity photodetector that is designed to detect small signals. If large reflections from the fibre are incident on the detector, saturation of the detection system can occur, which can lead to a “blind” section after the reflection, as the detector recovers from saturation. In the worst cases a large or time varying reflection incident on the detector can cause optical damage to the detector, and in particular the detector amplifier 118.

In situations where an optical fibre is being used for distributed sensing for the first time it would be possible to send a test signal into the fibre when connected to a less sensitive detector in order to ascertain if there are likely to be any problems.

However, in some instances an an optic fibre without any of the above mentioned problems may used for sensing without any concern and may later be damaged. Such damage could be caused by excavation at the location of a buried pipeline for example. In some instance such damage could occur between distinct periods of sensing or even during continuous sensing. If such damage occurs again an unexpected signal of large intensity may be reflected back down the optic fibre to the high sensitivity detector of the interrogator unit. Thus even with a fibre of known properties there are circumstances in which an unexpectedly intense signal can be received back from the detector.

In some instances a given sensor apparatus may be used for periodic monitoring in a given location and may only be connected to a fibre in-situ when monitoring is required.

This allows the same interrogator unit to be used with other fibres at other times. Whilst this means that, in theory, the properties of the fibre will be known from a previous monitoring session as mentioned above there are some instance where damage may occur between one period of sensing and the next. Also, in some instances there may be a number of different fibres in situ at a given location. In such cases it is possible that the interrogator may be connected to the wrong fibre by mistake, which could lead to a different fibre characteristic to that which was expected and which may include an unexpectedly high signal return.

A distributed sensor apparatus 200 of an embodiment of the present invention is shown in FIG. 2. In FIG. 2, features common with FIG. 1 are given the same reference numerals. For ease of reference, the interrogator unit 106 is only shown comprising detector 116. It should be appreciated that the interrogator unit 106 may comprise all of the units as shown in FIG. 1 and may also contain, integrally or otherwise, signal processor 108 and optionally a user interface/graphical display 110.

A fibre optic 104 is detachably coupled to the interrogator 106, as described in relation to FIG. 1. As described above, the optic fibre may be a pre-installed optic fibre, which may for example be located down a well bore.

As described above in relation to FIG. 1, in operation the interrogator 106 launches a series of optical pulses having a selected frequency pattern, into the sensing fibre. These pulses interact with the fibre and are backscattered due to intrinsic scattering sites along the length of the fibre 104. The high sensitivity photodetector 116 is arranged to detect the light that is backscattered from the scattering sites within the fibre 104.

An optical coupler 210, which may be tap coupler, couples/taps a small portion of the backscattered light signal that is propagating towards the detector 116. The tap coupler is configured to tap a small proportion of the light in the optic fibre for intensity detection, so as to minimise the impact on the signal strength of the light incident at the detector. The signals backscattered from the optic fibre to the photodetector 116 are generally small signals themselves, so it is desirable that as little loss as possible is experienced in the signals detected in the photodetector 116 as a result of the optical coupler. The tap coupler may tap 25% or less (in terms of intensity) of the light in the optic fibre. Preferably, the tap coupler may tap 10% of less of the light in the optic fibre.

The optical coupler may be any suitable optical coupler that can couple a portion of the reflected light in the optical path of the optic fibre for intensity detection.

An intensity detector 212 is arranged to determine the intensity of the sampled light from the tap coupler 210. Although FIG. 2 shows the optical coupler and the intensity detector as separate units, it should be understood that they may be integrally provided.

The intensity detector may comprise a threshold detector (not shown), which may be configured to determine whether or not the determined intensity exceeds a threshold value.

If the intensity detector 212 determines that the intensity of the backscattered light is greater than the threshold value, this may be indicative of a large reflected signal in the optic fibre propagating towards the detector 116, that may saturate or damage the detector 116.

As the intensity of the light detected by the intensity detector 212 is in proportion to the intensity of the light propagating in the optic fibre, by setting the threshold value at an appropriate level, the intensity detector can determine if the intensity of the light in the optic fibre is of a safe level for reception by the detector. In other words, the threshold is set such that, if the intensity of the sampled light is below the threshold value, the intensity of reflected light in the optic fibre will be at a safe level for the detector 116 and will not cause saturation or damage, and if the intensity of the sampled light is above the threshold value, the intensity of reflected light in the optic fibre will be at a level that may cause saturation or damage of the detector 116.

If the intensity detector determines that the intensity of the sampled light from the tap coupler 210 is greater than the threshold value, an optical attenuator 214, that is provided in the optical path between the optic fibre and the photodetector 116, is configured to limit the intensity of the light incident on the high sensitivity photodetector 116.

The optical attenuator 214 may be an optical switch that is arranged to be closed when the intensity of the sampled light from the tap coupler 210 is greater than the threshold value. This would act to prevent any light from the optic fibre 104 being incident on the detector 116. The optical switch may remain closed for a predetermined period of time. Alternatively, the optical switch 214 may remain in the closed position until the intensity detector 212 determines that the sampled light is less than the threshold value, indicating that the intensity of light that will be incident on the photodetector 116 is of a safe level.

In an embodiment of the present invention, the optical attenuator 214 may be a variable attenuator that is arranged to attenuate the light in the optical path at a level dependent on the intensity of the light detected by the intensity detector 212. The attenuator may be controlled by an attenuation controller that is operated based on the level of the optical attenuator is set in dependence on the intensity level detected by the intensity detector 212.

In this embodiment, the variable attenuation may be configured to apply a large attenuation when the intensity detector detects large signals and to apply a smaller attenuation when the intensity detector detects signals of lower intensity.

The distributed sensor of the present invention ensures that, by monitoring a sample of the reflected signal in the optic fibre, if a reflected signal is present with an intensity that is at a dangerous level, this signal can be attenuated such that the saturation of and damage to the detector can be prevented.

FIG. 3 shows a distributed sensor 300 of an embodiment of the present invention. In FIG. 3, features consistent with FIG. 2 are given the same reference numbers and will not be described again for conciseness.

In addition to the features described above in relation to FIG. 2, the distributed sensor apparatus of FIG. 3 also comprises a gain element 320, and a delay element 322.

The gain element 320 may be an amplifier that is arranged to amplify the sampled light. The gain element may be provided in order to amplify the signal used by the intensity detector. As indicated above, the optical coupler 201 is configured to tap a small proportion of the light in the optic fibre for intensity detection, so as to minimise the impact on the signal strength of the light incident at the detector. The signals backscattered from the optic fibre to the photodetector 116 are generally small signals themselves, so it is desirable that as little loss as possible is experienced in the signals detected in the photodetector 116 as a result of the optical coupler. These small sampled signal may therefore be amplified before they are passed to the intensity detector 212.

It should be noted that in this embodiment, any threshold value of the intensity detector will be set taking into account the gain of the gain element 320.

If extremely large, i.e. high intensity, reflections are expected, the gain element 320 may be an attenuator that is provided to protect the photodetector in the threshold detector 212.

It will be appreciated that although the threshold detector 212 is shown as a single unit, the determination of the intensity of the sampled light and the comparison of that intensity with a threshold value may be performed in separate elements. For example, a photodetector and a comparator may be provided.

The delay element 322 is provided in order to take into account the inherent delay that is associated with the electronic processing of the sampled signal and the optical attenuator. This electronic delay may typically be of the order of a few hundred of nanoseconds. In order to prevent potentially hazardous reflected optical signals from reaching the photodetector 116 before the optical attenuator can be controlled to attenuate the signal, the optical signal in the optical path between the optic fibre 104 and the photodetector 116 is therefore delayed by an optical delay.

The optical delay 324 shown in FIG. 3 is an optical delay coil. The optical delay coil 324 comprises a coil of appropriate fibre and length to ensure that the optical signal arrives at the attenuator sometime after a time period in which the necessary processing of the sampled signal and control of the attenuator can be performed. It will of course be appreciated that the delay coil may be formed from the optic fibre 104 itself and simply provides an optical delay for light reaching the attenuator 214 that is greater than the required measurement/processing delay.

Whilst endeavouring in the foregoing specification to draw attention to draw attention to those features of the invention believed to be of particular importance, it should be understood that the applicant claims protection in respect of any patentable feature or combination of features hereinbefore referred to and/or shown in the drawings whether or not particular emphasis has been placed thereon.

1. An apparatus for distributed fibre optic sensing, comprising:
an interrogator unit configured, in use, to interrogate an optic fibre with interrogating radiation and detect radiation backscattered from said optic fibre, the interrogator unit comprising:
a first detector configured to receive radiation from said optic fibre;
an intensity detector configured to determine an intensity level of the radiation received from the optic fibre; and
an optical attenuator configured to attenuate radiation passing from the optic fibre to the first detector in response to the intensity detector.

2. An apparatus according to claim 1, wherein the intensity detector comprises a second detector configured to determine an intensity level of the radiation received from the optic fibre.

3. An apparatus according to claim 2, wherein the intensity detector comprises an optical coupler configured to couple a portion of the radiation passing from the optical fibre to the first detector for detection by the second detector.

4. An apparatus according to claim 3, wherein the optical coupler is a tap coupler.

5. An apparatus according to claim 3, further comprising a gain element configured to apply a gain to the portion of the radiation coupled for detection by the second detector.

6. An apparatus according to claim 5, wherein the gain element is an amplifier configured to amplify the portion of the radiation.

7. An apparatus according to claim 1, wherein the intensity detector comprises a threshold detector configured to determine if the intensity level of the radiation received from the optic fibre is above a threshold level.

8. An apparatus according to claim 7, wherein (i) the threshold value is a predetermined threshold value or (ii) the distributed sensor further comprises a gain element configured to apply a gain to the portion of the radiation coupled for detection by the second detector, and the threshold value is a variable threshold value, wherein the threshold value is set in accordance with the gain of the gain element.

9. (canceled)

10. An apparatus according to claim 1, wherein the optical attenuator is configured to selectively apply attenuation at a fixed level to the radiation passing from the optic fibre to the first detector.

11. An apparatus according to claim 10, wherein the optic attenuator is an optical switch that is configured to be closed when the intensity level of the radiation received from the optic fibre is above a threshold level.

12. An apparatus according to claim 11, further comprising a switch controller configured to control the optical switch based on the output of the intensity detector.

13. An apparatus according to claim 1, wherein the optical attenuator is configured to apply a variable attenuation to the radiation passing from the optic fibre to the first detector.

14. An apparatus according to claim 13, further comprising an attenuation controller configured to vary the level of attenuation in dependence on the intensity level of the radiation received from the optic fibre.

15. An apparatus according to claim 1, further comprising a delay in the optical path between the optic fibre and the first detector.

16. A distributed sensor according to claim 15, wherein the delay is an optical delay coil.

17. A distributed sensor according to claim 1, wherein the intensity detector is configured to continuously determine the intensity of the radiation received from the optic fibre.

18. A distributed sensor according to claim 1, wherein the interrogator further comprises a light source for transmitting light into the optic fibre.

19. A distributed sensor according to claim 18, wherein the interrogator detector is configured to detect backscattered light.

20. A distributed sensor according to claim 19, wherein the distributed sensor is a distributed acoustic sensor.

21. A method of fibre optic distributed sensing, comprising:
interrogating an optic fibre with interrogating radiation;
determining an intensity level of backscattered radiation received from the optic fibre; and
attenuating the radiation received from the optic fibre in response to the determined intensity level.

22. (canceled)
